(19) United States
(12) Patent Application Publication
(10) Pub. No.: US 2026/0273988 A1
(43) Pub. Date: Sep. 17, 2026

(54) ANTI-COUNTERFEIT SYSTEMS AND METHODS

(71) Applicant: Nano and Advanced Materials Institute Limited, Hong Kong (HK)

(72) Inventors: Ka Wah HAU, Hong Kong (HK); Chi Ho KWOK, Hong Kong (HK); Lin CONG, Hong Kong (HK); Li FU, Hong Kong (HK)

(21) Appl. No.: 19/333,380

(22) Filed: Sep. 19, 2025

Related U.S. Application Data
(60) Provisional application No. 63/771,680, filed on Mar. 14, 2025.

(51) Int. Cl. B42D 25/382; G01N 21/3563; G01N 21/359; G06K 1/12; G06T 3/40; G06T 5/20; G06T 5/40; G06T 5/70; G06V 10/75; G06V 20/00

(52) U.S. Cl. CPC B42D 25/382; G01N 21/3563; G01N 21/359; G06K 1/121; G06T 3/40; G06T 5/20; G06T 5/40; G06T 5/70; G06V 10/751; G06V 20/95; G06T 2207/10024; G06T 2207/10048; G06T 2207/20192; G06T 2207/30176; G06V 2201/09

(57) ABSTRACT

An anti-counterfeit system including a dual-functional security ink composition exhibiting both near-infrared (NIR) absorption and visible coloration, characterized by a viscosity of 10-1,250 cP and a pH of 6-8, is provided. The system includes a security feature printing module for producing a machine-readable security feature detectable under visible light and NIR illumination at 700-1,000 nm. An image acquisition device, incorporating a portable NIR imaging camera or scanner and an optical camera, is used to capture corresponding NIR and optical images of the security feature. A computer system processes the captured NIR image through a multi-stage enhancement pipeline.

### CROSS-REFERENCE TO RELATED APPLICATIONS

The present application claims priority from U.S. Provisional Utility Patent application No. 63/771,680 filed Mar. 14, 2025; the disclosure of which is incorporated herein by reference in its entirety.

### FIELD OF THE INVENTION

The present invention generally relates to security printing and anti-counterfeiting technologies. More specifically, the present invention relates to anti-counterfeit systems and methods utilizing near-infrared (NIR)-visible dual-functional ink compositions.

### BACKGROUND OF THE INVENTION

Counterfeiting remains a persistent and widespread issue across numerous industries, including pharmaceuticals, luxury goods, finance, and high-value consumer products. To prevent unauthorized replication, anti-counterfeiting labels are often equipped with a range of security features such as holograms, color-shifting inks, chemical markers, and radio-frequency identification (RFID) tags. Among these, near-infrared (NIR) absorbing inks have emerged as a promising covert authentication technology. These inks are invisible under visible light but can be reliably detected using specialized NIR imaging or scanning systems, enabling secure and unobtrusive verification.

Despite their advantages, the broader adoption of NIR-absorbing inks is hindered by several technical challenges. One of the primary concerns is the stability of NIR-absorbing compounds. Many organic dyes and pigments commonly used in such formulations are susceptible to photodegradation, resulting in diminished NIR absorption over time when exposed to light, heat, or moisture. Inorganic alternatives such as indium tin oxide (ITO) offer improved durability and photostability but are often expensive and limited in terms of dispersion, compatibility with common ink vehicles, or printability.

In addition to stability, aesthetic compatibility presents another obstacle. Security inks must not only provide effective NIR absorption but also meet design requirements for visible appearance. Many NIR-absorbing materials exhibit dark or opaque coloration, which may be unsuitable for applications requiring vibrant or light-colored printed surfaces. Achieving a balance between visible aesthetics and NIR functionality necessitates precise formulation strategies to ensure that the ink provides reliable covert features without compromising product presentation.

Detection reliability is another critical parameter influencing the effectiveness of NIR security inks. For a security feature to be reliable, the absorption intensity must be sufficient for consistent detection across varying substrates, surface textures, and lighting conditions. Factors such as ink layer thickness, substrate reflectivity, and background interference can adversely impact NIR signal clarity, potentially leading to false negatives during authentication. Therefore, enhancing the signal consistency and robustness across diverse application environments remains a key technical objective.

To address these challenges and stay ahead of increasingly sophisticated counterfeiting methods, manufacturers are turning to multi-spectral authentication systems, integrating NIR absorption with advanced techniques such as fluorescence, phosphorescence, thermochromism, and polarization. Hybrid ink formulations that combine stable inorganic nanoparticles with tunable organic chromophores offer a promising pathway to improve both durability and visual flexibility. These advances aim to deliver secure, printable inks with optimized performance for real-world anti-counterfeiting applications.

Accordingly, the present invention is directed to an anti-counterfeit system incorporating an improved NIR-visible dual-functional ink composition that addresses the above shortcomings by providing a stable, dual-detection ink formulation with enhanced printability, color customization, and detection reliability.

### SUMMARY OF THE INVENTION

It is an objective of the present invention to provide the systems and methods to solve the aforementioned technical problems.

In accordance with a first aspect of the present invention, an anti-counterfeit system is provided. Specifically, the anti-counterfeit system includes the following components: a dual-functional security ink composition exhibiting both NIR absorption and visible coloration, having a viscosity of 10 to 1,250 cP and a pH between 6 and 8, including: a NIR absorbing compound and one or more visible colorants in an amount ranging from 0.5% to 10% w/w; a security feature printing module configured to print a security feature using the dual-functional security ink composition, wherein the security feature is machine-readable under illumination with NIR light in the wavelength range of 700-1,000 nm and detectable under visible light; an image acquisition device including a portable NIR imaging camera or scanner configured to capture an NIR image of the security feature and an optical image camera configured to capture an optical image of the security feature; and a computer system configured to process the NIR image of the security feature through: applying a bilateral filtering to the NIR image to reduce noise while preserving edge features; performing a contrast-limited adaptive histogram equalization (CLAHE) on the filtered NIR image to enhance local contrast between inked regions and a background substrate; converting the contrast-enhanced image into a binary image using Otsu thresholding; performing image upscaling to improve resolution of the binary image; and generating an enhanced NIR image suitable.

In accordance with one embodiment, the NIR absorbing compound includes one or more of: a nickel dithiolene derivative, having the formula:

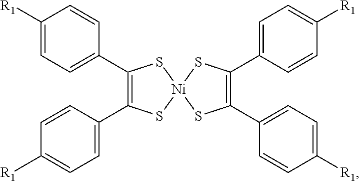

wherein R₁ is a hydrogen atom, aryl, arylalkyl, substituted aromatic cycles containing halogen, halo alkyl, ester, imide, diimide, nitro, cyano, carbonyl, or sulfonyl group; a nickel phenylenediamine derivative, having the formula:

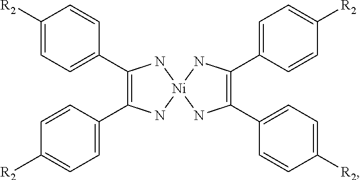

wherein R₂ is a hydrogen atom, aryl, arylalkyl, substituted aromatic cycles containing halogen, halo alkyl, ester, imide, diimide, nitro, cyano, carbonyl, or sulfonyl group; copper phosphate ester having the formula of CuPO₃R₃, wherein R₃ is a hydrogen atom, alkyl or alkoxy group; and cesium tungsten oxide having the formula of: CsₓWO₃, wherein 0<x<1.

In accordance with another embodiment, the ratio of visible colorant to NIR absorbing compound is selected to produce a visibly colored security feature detectable under visible light or a visibly colorless security feature detectable only under NIR light.

In accordance with yet another embodiment, the computer system further comprises a step of comparing the enhanced NIR image with a stored reference image of the security feature for evaluate the authentication of the security feature.

In accordance with yet another embodiment, the security feature comprises one or more of a barcode, microtext, a logo, a QR code, or a geometric pattern.

In accordance with yet another embodiment, the NIR image acquisition device is integrated into a mobile device, smartphone, or handheld scanner.

In accordance with yet another embodiment, the enhanced NIR image is used for real-time authentication of secure documents, currency, identification cards, or product packaging.

In accordance with yet another embodiment, the computer system is further configured to output an authentication signal to a user interface indicating whether the security feature is verified or counterfeit.

In accordance with yet another embodiment, the dual-functional security ink composition further includes: one or more additives in an amount ranging from 2% to 8% w/w, including at least one surfactant; and a solvent in an amount ranging from 70% to 90% w/w; wherein the at least one surfactant includes ethylene glycol, polyethylene glycol, or a combination thereof, and the solvent includes one or more of water, alcohols, polyols, esters, ketones, and glycerol.

In accordance with yet another embodiment, the visible colorants provide visible coloration under daylight and includes one or more of acid dyes, basic dyes, solvent dyes, direct dyes, disperse dyes, mordant dyes and reactive dyes.

In accordance with yet another embodiment, the NIR absorbing compound has an average particle size (d₅₀) not exceeding 50 nm.

In accordance with yet another embodiment, the NIR absorbing compound has a lightfastness rating of at least 5 on the international blue wool scale, providing long-term durability and resistance to fading.

In accordance with yet another embodiment, the dual-functional security ink composition maintains at least 90% of its initial NIR reflectance properties after humidity aging at 85° C. and 85% relative humidity for 500 hours.

In accordance with yet another embodiment, the NIR absorbing compound exhibits high optical stability, minimizing the degradation under prolonged exposure to UV light, heat, or humidity.

In accordance with a second aspect of the present invention, a method of authenticating a security feature printed with a dual-functional ink composition is provided. Specifically, the method includes: capturing a NIR image of the security feature using an NIR imaging device, the ink composition exhibiting NIR absorption in the wavelength range of 700-1,000 nm, in which the security feature is in a visibly colored or a visibly colorless form; applying a bilateral filtering to the NIR image to reduce noise while preserving edge features; performing a CLAHE on the filtered image to enhance local contrast between inked regions and a background substrate; converting the contrast-enhanced image into a binary image using Otsu thresholding; performing image upscaling to improve resolution of the binary image; generating an enhanced NIR image; and comparing the enhanced NIR image with a stored reference image of the security feature to generate an authentication result.

In accordance with one embodiment, the dual-functional ink composition exhibits both NIR absorption and visible coloration, having a viscosity of 10 to 1,250 cP and a pH between 6 and 8, including: a NIR absorbing compound includes one or more of: a nickel dithiolene derivative, having the formula:

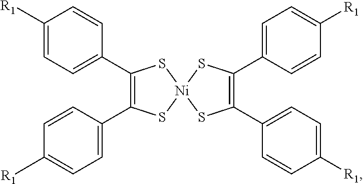

wherein R₁ is a hydrogen atom, aryl, arylalkyl, substituted aromatic cycles containing halogen, halo alkyl, ester, imide, diimide, nitro, cyano, carbonyl, or sulfonyl group; a nickel phenylenediamine derivative, having the formula:

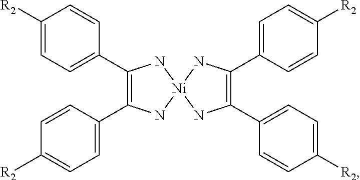

wherein R₂ is a hydrogen atom, aryl, arylalkyl, substituted aromatic cycles containing halogen, halo alkyl, ester, imide, diimide, nitro, cyano, carbonyl, or sulfonyl group; copper phosphate ester having the formula of CuPO₃R₃, wherein R₃ is a hydrogen atom, alkyl or alkoxy group; and cesium tungsten oxide having the formula of: CsₓWO₃, wherein 0<x<1; and one or more visible colorants in an amount ranging from 0.5% to 10% w/w.

In accordance with another embodiment, the method further includes performing spectral analysis of the enhanced NIR image to verify the presence of the dual-functional ink composition.

In accordance with yet another embodiment, the security feature comprises one or more of a barcode, QR code, logo, microtext, or geometric pattern.

In accordance with yet another embodiment, the authentication result is output through a user interface as a verification signal indicating whether the security feature is genuine or counterfeit.

In accordance with yet another embodiment, the security feature is printed on a substrate comprising a paper, a polymer film, a metal foil, and a product packaging.

In accordance with yet another embodiment, the comparison is performed in real-time using a mobile device, smartphone, or portable scanner.

In accordance with yet another embodiment, the dual-functional ink composition further includes: one or more additives in an amount ranging from 2% to 8% w/w, comprising at least one surfactant; and a solvent in an amount ranging from 70% to 90% w/w; wherein the at least one surfactant comprises ethylene glycol, polyethylene glycol, or a combination thereof, and the solvent comprises one or more of water, alcohols, polyols, esters, ketones, and glycerol.

In accordance with yet another embodiment, the visible colorants provide visible coloration under daylight and includes one or more of acid dyes, basic dyes, solvent dyes, direct dyes, disperse dyes, mordant dyes and reactive dyes.

### BRIEF DESCRIPTION OF THE DRAWINGS

Embodiments of the invention are described in more details hereinafter with reference to the drawings, in which:

FIG. 1 depicts the algorithm workflow, where sequential steps transform a noisy NIR input into a machine-readable output for authentication;

FIGS. 2A-2B depict a scanning electron microscope (SEM) image of the milled particle (FIG. 2A) and corresponding particle size distribution data obtained from a particle size analyzer (FIG. 2B);

FIG. 3 depicts the results of an accelerated aging test performed on the ink compositions;

FIGS. 4A and 4B respectively show the results of a Xenon arc lamp aging test on the ink composition of Example 2 (FIG. 4A) and a benchmark NIR ink composition (FIG. 4B);

FIG. 5 shows the aging test results for the cesium tungsten oxide (CWO)-based sample;

FIGS. 6A and 6B respectively show the Xenon arc lamp aging test results for the CWO-based sample (FIG. 6A) and the benchmark NIR ink composition (FIG. 6B);

FIG. 7 depicts the NIR signal of the Example 3 ink composition as observed using an infrared imaging device;

FIGS. 8A and 8B depict the dual-mode imaging results showing the NIR-sensitive capture of a covert QR code printed with invisible ink (FIG. 8A), and the corresponding RGB-visible image displaying only the aesthetic logo design (FIG. 8B), with no discernible interference from the embedded machine-readable data; and

FIG. 9 depicts a block diagram showing an anti-counterfeit system in according to one embodiment of the present invention.

### DETAILED DESCRIPTION

In the following description, anti-counterfeit systems and/or methods and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

A security NIR-visible dual-functional ink is a specialized ink formulation designed to exhibit both visible color under standard lighting conditions and NIR absorption properties detectable under NIR imaging or authentication systems. This ink typically comprises visible colorants (such as dyes or pigments) for conventional appearance and NIR-absorbing compounds (such as nickel dithiolene complexes, copper phosphate esters, or cesium tungsten oxides) that interact with infrared light at specific wavelengths.

Such dual-functional inks are primarily used in anti-counterfeiting applications, including security printing, authentication labels, brand protection, and document security. The dual functionality allows for covert security features that remain undetectable to the naked eye but are easily verified using NIR detection equipment. Additionally, these inks may include stabilizing additives, surfactants, and optimized solvents to ensure printability, durability, and resistance to environmental degradation.

Using anti-counterfeit labels with a dual-functional ink that has both visible and NIR absorbing properties is particularly valuable for providing enhanced security and versatility in authentication systems. This type of ink is designed to exhibit both visible and machine-detectable properties, making it suitable for applications requiring aesthetic appeal and security features.

The term “NIR absorbing compound” refers to a NIR absorber that contains materials that absorb light in the near-infrared region (700-2500 nm), detectable by NIR cameras or spectrometers. Examples include:
Rare-earth doped materials (e.g., Nd, Er compounds);
Semiconductor nanoparticles (e.g., quantum dots);
Carbon-based materials (e.g., carbon black, graphene); and
Organic NIR dyes (e.g., phthalocyanines, squaraines).

The term “colorant” includes pigments or dyes that absorb light in the visible spectrum (400-700 nm) to produce a specific color visible to the human eye. Examples include organic dyes like azo compounds or inorganic pigments like titanium dioxide-based mixtures.

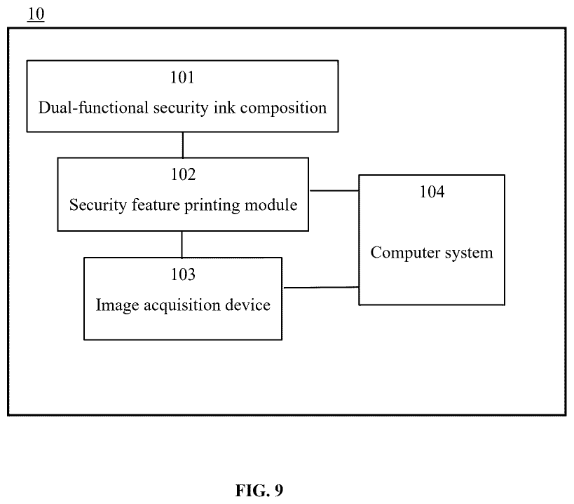

In accordance with a first aspect of the present invention, an anti-counterfeit system is provided. Referring to FIG. 9, an anti-counterfeit system 10 in according to one embodiment of the present invention is depicted. The anti-counterfeit system 10 is designed to enhance security through the integration of a dual-functional ink composition 101, a security feature printing module 102, an image acquisition device 103, and a computer system 104 for processing computer-based image processing pipeline. At the core of the system 10 is a specially engineered dual-functional security ink composition 101 that exhibits both NIR absorption and visible coloration. The ink composition is formulated to have a viscosity between 10 and 1,250 cP and a pH range of 6 to 8, ensuring stability and printability across a variety of substrates. In some embodiments, the viscosity is selected from narrower ranges such as 10-20 cP, 500-1,250 cP, or the full 10-1,250 cP range, depending on the specific printing method and substrate requirements.

It is worth noting that the ink is suitable for use with multiple printing technologies, including offset printing, inkjet printing, screen printing, UV inkjet printing, and other comparable processes, thereby providing broad compatibility and flexibility in manufacturing secure printed features.

The ink composition includes a NIR absorbing compound in an amount ranging from 0.5% to 10% by weight (w/w), which includes one or more of the following components: a nickel dithiolene derivative having the general formula:

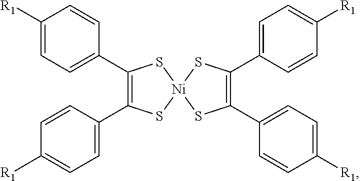

wherein the substituent R₁ is selected from hydrogen atoms, aryl or arylalkyl groups, or substituted aromatic cycles containing functional groups such as halogen, haloalkyl, ester, imide, diimide, nitro, cyano, carbonyl, or sulfonyl; a nickel phenylenediamine derivative having the general formula:

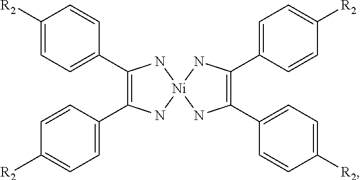

wherein the substituent R₂ similarly includes hydrogen, aryl, arylalkyl, or substituted aromatic cycles with comparable functional groups; a copper phosphate ester represented by the formula CuPO₃R₃, wherein R₃ is a hydrogen atom, alkyl group, or alkoxy group; and cesium tungsten oxide, expressed by the formula CsₓWO₃, where the molar ratio x is greater than 0 and less than 1. These compounds are selected for their strong absorption in the NIR wavelength region and their compatibility with ink systems.

To provide visible coloration for overt authentication and branding aesthetics, or to remain substantially colorless for covert authentication, the ink composition 101 may further include one or more visible colorants in the range of 0.5% to 10% w/w. In embodiments where overt visual features are desired, the colorants are selected from acid dyes, basic dyes, solvent dyes, direct dyes, disperse dyes, mordant dyes, and reactive dyes, which are capable of delivering vibrant, stable coloration under daylight conditions without interfering with the NIR properties. In alternative embodiments, the ink composition may be formulated to omit or minimize visible colorants so as to produce a substantially invisible mark under visible light while remaining clearly detectable under NIR illumination.

The ink composition 101 also contains one or more additives in a total amount ranging from 2% to 8% w/w, including at least one surfactant to assist with pigment dispersion and print uniformity. Preferred surfactants include ethylene glycol, polyethylene glycol, or combinations thereof, which contribute to ink stability and rheology control.

A solvent is incorporated to achieve the desired viscosity and printability, constituting 70% to 90% w/w of the total formulation. Suitable solvents include water, alcohols, polyols, esters, ketones, and glycerol, which provide compatibility with a variety of commercial printing systems.

The ink composition 101 is designed with superior material characteristics for long-term performance. In certain embodiments, the NIR absorbing compound has an average particle size (d₅₀) not exceeding 50 nm, enhancing its optical performance. The compound further exhibits a lightfastness rating of at least 5 on the international blue wool scale, ensuring resistance to fading. Additionally, the dual-functional ink maintains at least 90% of its initial NIR reflectance properties even after humidity aging at 85° C. and 85% relative humidity for 500 hours. The NIR absorbing compound also demonstrates high optical stability, minimizing degradation under prolonged exposure to ultraviolet light, heat, or humidity.

The anti-counterfeit system 10 further includes a security feature printing module 102 configured to print security features using the ink composition 101. These features may include barcodes, microtext, logos, QR codes, or geometric patterns. Once printed, the features are machine-readable under illumination with NIR light in the wavelength range of 700-1,000 nm while remaining visually distinct under standard visible light.

An image acquisition device 103 is employed to capture both NIR and optical images of the printed security feature. The device 103 includes a portable NIR imaging camera or scanner configured to capture NIR images, and an optical camera configured to capture visible optical images. In some embodiments, the NIR image acquisition device 103 may be integrated into a mobile device, smartphone, or handheld scanner, enabling convenient and portable authentication.

A computer system 104 is provided to process the NIR images of the security feature. The computer system 104 executes a multi-stage image enhancement pipeline. First, bilateral filtering is applied to reduce noise while preserving the edge features critical to security pattern recognition. Next, contrast-limited adaptive histogram equalization (CLAHE) is performed to enhance local contrast between inked regions and the background substrate. Following contrast enhancement, Otsu thresholding is used to convert the image into a binary representation, automatically determining the optimal threshold for feature isolation. The binary image is then subjected to image upscaling to improve resolution, generating an enhanced NIR image that can be reliably analyzed.

The enhanced image may be further processed by comparing it with a stored reference image of the security feature to evaluate authenticity. The computer system 104 can also perform pattern recognition or spectral analysis on the enhanced image. The authentication result is provided to a user interface (not shown), where an authentication signal indicates whether the security feature is genuine or counterfeit. This process enables real-time authentication of secure documents, currency, identification cards, or product packaging.

In some embodiments, the computer system 104 is configured to control the printing module 102 to apply the dual-functional security ink composition 101 onto a substrate according to predefined security patterns, such as barcodes, microtext, QR codes, logos, or geometric designs. This centralized control ensures that the printed security feature is applied with consistent ink distribution, resolution, and alignment, thereby preserving the NIR absorption and visible coloration characteristics of the ink.

The computer system 104 also communicates with the image acquisition device 103. Under system operation, the computer system 104 may send commands to trigger the image acquisition device 103, capture both visible and NIR images of the security feature, and relay the captured data for analysis. Through this integration, the computer system 104 coordinates the end-to-end process of generating the security feature, acquiring the authentication image, processing the image, and outputting an authentication result. In certain implementations, the computer system 104 may be implemented on a dedicated hardware unit, a desktop computer, a mobile device, or a cloud-based server.

Through the integration of a dual-functional security ink composition with advanced optical stability, a flexible printing module, a portable image acquisition device, and an intelligent computer vision system, the present invention provides a robust anti-counterfeit system with high durability, reliability, and real-time verification capabilities.

In accordance with a second aspect of the present invention, a method of authenticating a security feature printed with a dual-functional ink composition that exhibits both NIR absorption and visible coloration is provided. The authentication process begins by capturing a raw NIR image of the printed security feature using an NIR imaging device. The NIR imaging device is configured to detect wavelengths in the range of 700-1,000 nm, ensuring that the distinct NIR absorption properties of the ink composition are recorded. The ink composition may be formulated either to exhibit visible coloration for human inspection or to remain substantially colorless under visible light, depending on the intended application. The ink may be characterized by a viscosity of 10 to 1,250 cP and a pH between 6 and 8. It is worth noting that the dual-functional ink composition has the aforementioned compounds, components and features.

Once the NIR image is captured, the method subjects the image to a multi-stage enhancement process to improve reliability of authentication. A bilateral filter is first applied to the NIR image to reduce noise while preserving edge features critical to the integrity of the printed pattern. The filtered image is then processed using CLAHE, which enhances the local contrast between inked regions and the background substrate, thereby improving differentiation of the security feature. The contrast-enhanced image is subsequently converted into a binary representation by Otsu thresholding, which automatically identifies an optimal intensity threshold to separate inked regions from background. Thereafter, image upscaling is performed on the binary image to increase resolution, improving fine-feature recognition in the enhanced NIR image. The resulting enhanced NIR image provides a machine-readable output with sufficient clarity for comparison.

The method further includes comparing the enhanced NIR image with a stored reference image of the intended security feature to generate an authentication result. In some embodiments, the comparison may be supplemented with spectral analysis of the enhanced NIR image to confirm the presence of the dual-functional ink composition, thereby adding an additional layer of verification. The authentication process is designed for real-time implementation and the result can be output through a user interface as a verification signal indicating whether the security feature is genuine or counterfeit.

The security feature printed with the dual-functional ink composition may take various forms, including barcodes, QR codes, logos, microtext, or geometric patterns, and may be applied to diverse substrates such as paper, polymer films, metal foils, or product packaging. The authentication method is compatible with mobile devices, smartphones, and portable scanners, making it suitable for real-time verification in field applications.

Altogether, the method provides a robust multi-step image processing pipeline integrated with the unique dual-functional ink composition, enabling reliable authentication of security features through combined optical and spectral analysis.

### EXAMPLES

### Example 1: The Anti-Counterfeit Pipeline

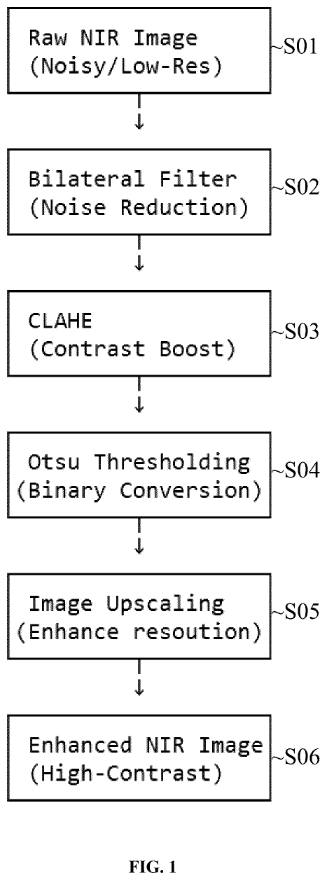

Referring to FIG. 1, the authentication process begins with capturing a NIR image of the security feature printed using the dual-functional ink composition. The raw NIR image (S01), which often contains noise and exhibits low contrast, is subjected to a multi-stage enhancement pipeline. In the first stage, a bilateral filter is applied to reduce noise while preserving critical edge details of the security pattern (S02). The filtered image is then processed with CLAHE, which amplifies local contrast between the NIR-absorbing ink regions and the background substrate (S03). Next, the contrast-enhanced image is converted into a binary format using Otsu's thresholding method, which automatically selects an optimal intensity threshold to separate the security feature from the background (S04). Optionally, image upscaling may be applied to increase resolution and improve recognition of fine structural details (S05). The resulting enhanced NIR image supports reliable authentication through either pattern matching or spectral analysis, leveraging the ink's unique NIR absorption properties as a distinct machine-readable signature (S06). This algorithmic pipeline is particularly effective for the disclosed ink formulation, as the combination of edge-preserving noise reduction and adaptive contrast enhancement maximizes the visibility of the ink's NIR absorption profile while mitigating common imaging artifacts.

### Example 2: Synthesis of NIR Absorber

Anisil (50 g, 0.238 mol) is dissolved in toluene (300 mL) at 80° C. Lawesson's reagent (90.62 g, 0.238 mol) is then added to the solution at the same temperature. The reaction mixture is refluxed for 20 minutes, after which nickel metal (6.9 g, 0.119 mol) is added. The resulting mixture is further refluxed for 3 hours. Upon completion, the reaction mixture is cooled using an ice bath and subsequently poured into 150 parts of ethanol. The precipitate is collected by filtration, washed with ethanol, followed by warm water, and then dried to yield a compound having the following structural formula:

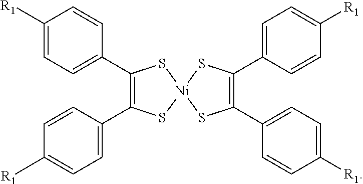

In certain embodiments, the present invention provides NIR-absorbing compositions suitable for invisible ink applications, as demonstrated by the comparative performance data in Table 1. The Ni-D series exhibits particularly advantageous properties, with Ni-D-3 showing exceptional absorption at 1,000 nm (¿=82,500 M⁻¹ cm⁻¹) while maintaining low reflectance (~40% at 800 nm) and minimal photoluminescence (PLQY<0.01), making it ideal for covert, wavelength-specific marking. In contrast, Cu-P-1, while displaying higher reflectance (~60%), suffers from significantly weaker absorption (ε=36.2 M⁻¹ cm⁻¹), highlighting the superior performance of nickel-based complexes. The data further reveals a consistent trend of decreasing reflectance with increasing concentration (comparing 3% vs 5% formulations), enabling tunable stealth properties through concentration adjustment. These compositions are particularly valuable for security applications requiring machine-detectable but visually imperceptible markings, with the absorption wavelength selectable between 780-1,200 nm to match specific detection systems.

TABLE 1

| | | | | Photo- |
|---|---|---|---|---|
| | Absorption | | | lumi- |
| NIR | Wavelength (nm) | | Reflectance | nescence |
| absorb- | (Extinction | | (R %) | quantum |
| ers | coefficient) | | @800 nm | yield (Φ) |
| Ni—N-1 | 780 nm | (23560 M⁻¹ cm⁻¹) | ~50% (3% conc.) | <0.01 |
| Cu—P-1 | 805 nm | (36.2 M⁻¹ cm⁻¹) | ~60% (3% conc.) | <0.01 |
| Ni-D-1 | 850 nm | (25600 M⁻¹ cm⁻¹) | ~40% (5% conc.) | <0.01 |
| Ni-D-2 | 900 nm | (13116 M⁻¹ cm⁻¹) | ~40% (5% conc.) | <0.01 |
| Ni-D-3 | 1000 nm | (82500 M⁻¹ cm⁻¹) | ~40% (5% conc.) | <0.01 |
| CWO | 1200 nm | (N.D.) | ~20% (5% conc.) | <0.01 |

### Example 3: Ball Milling of Cesium Tungsten Oxide (CWO)

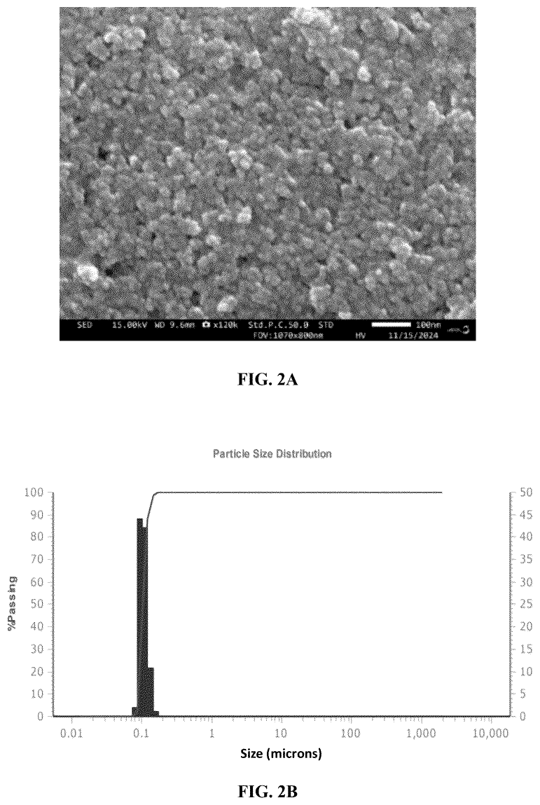

Cesium tungsten oxide (CWO) is processed via high-energy ball milling to produce a fine powder suitable for use as a near-infrared (NIR) absorber. Specifically, 3 grams of CWO are mixed with 100 mL of a commercially available UV-curable acrylate-based solvent and subjected to ball milling at 2000 rpm. The process yields a well-dispersed ink formulation with particle sizes reduced to below 50 nm. FIGS. 2A and 2B illustrate the scanning electron microscopy (SEM) image of the milled particles and the corresponding particle size distribution analysis, respectively.

### Example 4: Offset Printing Ink Composition

An offset printing ink composition is prepared by incorporating 3% by weight of the NIR absorber prepared in Example 2 or Example 3 into a commercial offset ink base. Additionally, 1% by weight of a visible colorant is added. The resulting mixture is stirred vigorously to ensure uniform dispersion.

An example of the commercial offset ink base comprises the following components by weight:
Linseed oil, soybean oil, and tung oil: 20-40%;
Rosin-modified phenolic resin: 25-50%;
Mineral oil: 15-30%;
Polyethylene wax: 0.2-2%; and
Drier: 0.5-2%.

In some formulations, an alternative offset resin system (“Offset Resin 2”) is used, which includes:
Polyurethane (PU)-based resin: 80-90%;
Ethyl acetate: 2-10%; and
Rheological additives: 1-10%.

### Example 5: Aging Test

The sample prepared in Example 2 (designated as Sample 1) is subjected to an accelerated humidity aging test. The test is conducted in a weathering chamber at 85° C. and 85% relative humidity for a duration of 500 hours, with the sample printed on paper substrate.

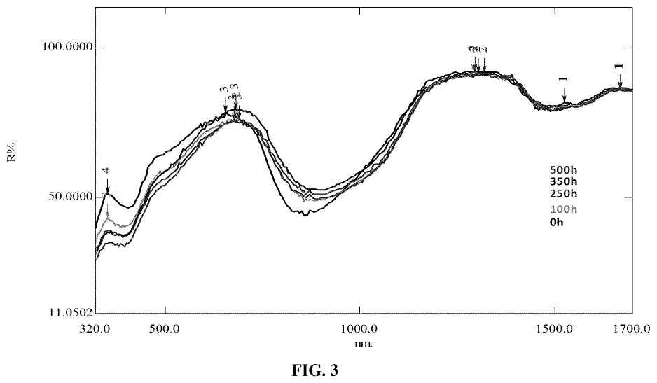

No significant change in reflectance is observed, indicating that the NIR-absorbing pigment in the ink formulation exhibits excellent stability and lightfastness under high-temperature and high-humidity conditions. The reflectance spectrum of Sample 1 is recorded and presented in FIG. 3, showing minimal spectral variation over time. Quantitative reflectance values correlated with aging duration are summarized in Table 2.

TABLE 2

| Aging hours | Example 1 sample R % |
|---|---|
| 0 | 45.35 |
| 100 | 48.90 |
| 250 | 49.44 |
| 350 | 52.42 |
| 500 | 50.92 |

### Example 6: Xenon Arc Weathering Test

Sample 1, prepared in Example 2, is subjected to a xenon arc weathering test to evaluate its light stability. The test is conducted using a xenon weather meter under conditions conforming to international weathering standards and evaluated using the Blue Wool Scale classification method.

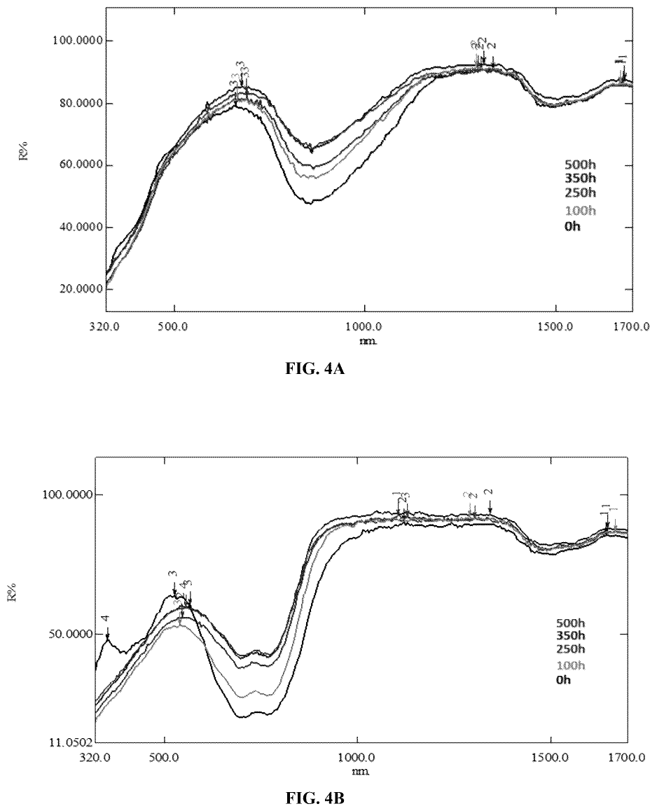

The xenon lamp is operated without water spray, with an irradiance of 42 W/m² in the 300-400 nm wavelength range. Reflectance measurements of Sample 1 over the course of the xenon exposure test are recorded and illustrated in FIGS. 4A and 4B.

The test results indicate that Sample 1 achieves a Blue Wool Scale rating of 5, demonstrating superior lightfastness compared to a benchmark NIR ink sample. The corresponding reflectance values over time are summarized in Table 3.

TABLE 3

| Aging hours | Example 1 sample R % | Benchmark NIR sample R % |
|---|---|---|
| 0 | 47.56 | 20.13 |
| 500 | 66.12 | 46.34 |
| Delta R % | 18.56 | 26.21 |

### Example 7: Aging Test on CWO Sample

A humidity aging test is performed on the CWO-based ink sample prepared in Example 3. The test is conducted in a weathering chamber at 85° C. and 85% relative humidity for 500 hours, with the ink printed on a paper substrate.

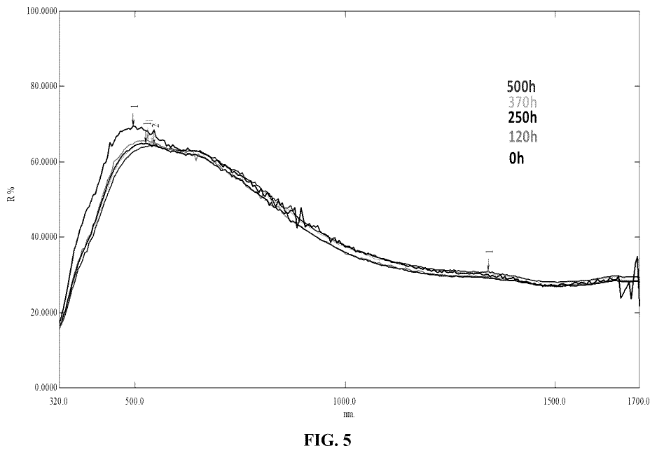

The results show no significant change in reflectance, indicating that the pigment does not undergo observable decomposition under these conditions. This demonstrates that the CWO-based formulation possesses excellent lightfastness and environmental stability. The reflectance spectrum of the Example 3 sample is presented in FIG. 5, and the corresponding reflectance values at various aging intervals are summarized in Table 4.

TABLE 4

| Aging hours | Example 1 sample R % |
|---|---|
| 0 | 27.47 |
| 120 | 27.44 |
| 250 | 27.25 |
| 370 | 28.26 |
| 500 | 28.32 |

### Example 8: Xenon Arc Aging Test on CWO Sample

Sample 2, prepared in Example 3 using CWO, is subjected to a xenon arc aging test to evaluate its light stability. The test is conducted using a xenon weather meter under conditions conforming to international weathering standards, with lightfastness assessed using the Blue Wool Scale.

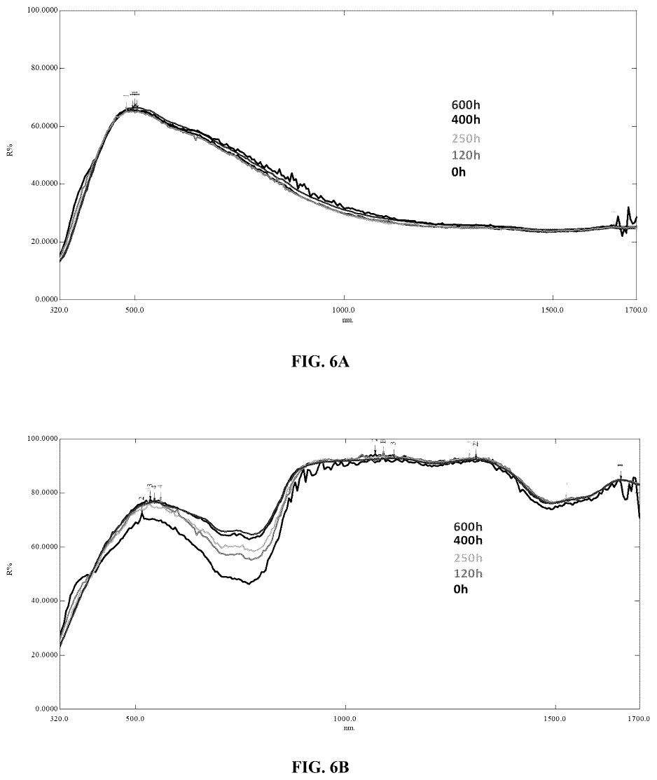

The xenon lamp operates without water spray and provides an irradiance of 42 W/m² in the 300-400 nm wavelength range. Reflectance measurements of the CWO-based sample during the test are recorded and illustrated in FIG. 6.

The results indicate that Sample 2 achieves a Blue Wool Scale rating of 5, demonstrating superior lightfastness compared to a benchmark NIR sample, in accordance with the Blue Wool standard. The corresponding reflectance values over time are summarized in Table 5.

TABLE 5

| Aging hours | Example 2 sample R % | Benchmark NIR sample R % |
|---|---|---|
| 0 | 12.43 | 46.81 |
| 120 | 12.16 | 55.61 |
| 200 | 23.79 | 56.53 |
| 250 | 23.73 | 59.46 |
| 400 | 23.69 | 63.29 |
| 600 | 24.39 | 65.07 |

### Example 9: Infrared Camera Observation

The NIR absorber from Example 3, following 500 hours of xenon lamp aging, is evaluated using an infrared (IR) camera to assess its NIR absorption performance. During the observation, illumination is provided by an infrared LED emitting at a wavelength of 940 nm. An optical filter is applied to block wavelengths below 820 nm, ensuring selective imaging in the NIR region.

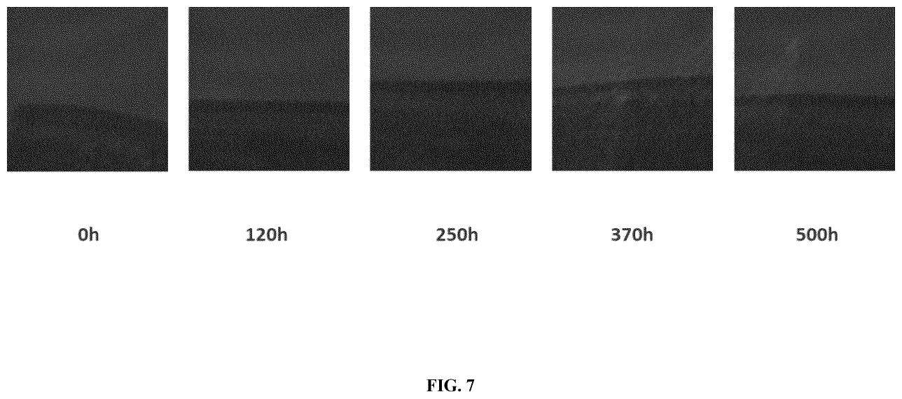

As shown in FIG. 7, the aged sample exhibits a distinct dark appearance under infrared imaging, confirming that the NIR absorption properties are retained after prolonged xenon exposure.

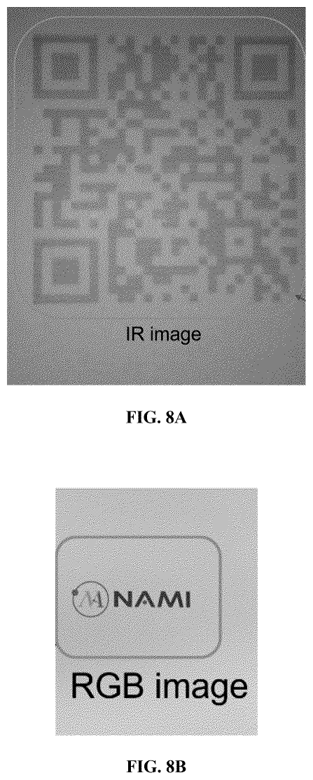

Furthermore, FIG. 8 demonstrates the dual-mode functionality of the invention, where a NIR invisible QR code is seamlessly integrated with a visually appealing RGB-printed logo. In the IR image, the QR code becomes clearly detectable under NIR illumination, allowing machine scanning for authentication, data retrieval, or interactive applications. Meanwhile, the RGB image shows only the decorative logo or design, preserving aesthetic integrity for human viewers. This contrast highlights the system's ability to combine covert machine-readable data with unobstructed visual branding—ideal for secure packaging, anti-counterfeiting measures, or augmented reality experiences without compromising design.

Referring to Table 6, the results further confirm that the disclosed dual-functional ink and image processing method operate in a synergistic manner. The superior performance of the ink formulation is not fully realized in isolation but becomes evident only when combined with the specific image enhancement sequence of bilateral filtering, CLAHE, Otsu thresholding, and image upscaling. This sequence uniquely translates the intrinsic optical properties of the ink into significantly improved authentication metrics. The cooperative effect of this algorithmic pipeline and the ink's NIR-visible dual functionality is essential for generating processed images with sharp edge definition, strong contrast, and reliable fine-feature readability. Such characteristics are critical for robust mobile-based authentication of security features, particularly under variable imaging conditions. Accordingly, the synergy between the claimed ink composition and processing method provides a distinct technical advantage over conventional approaches.

TABLE 6

| Ink | | Edge | Local | Fine Feature | |
|---|---|---|---|---|---|
| Formulation | Processing Method | Preservation | Contrast | Readability | Mobile Use |
| Ink with | The method presented | High (edges | Strong | Excellent | Very Good |
| Example 2 | by the present invention | remain distinct) | (background | (Microtext, QR | (Real-time on |
| Absorber | (Bilateral → CLAHE → | | variations are | codes, and | handheld and |
| | Otsu → Upscaling) | | well | patterns | mobile devices) |
| | | | compensated) | resolved | |
| | | | | clearly) | |
| Ink with | Simple Thresholding | Low (fine edges | Weak (Noise | Poor (Small | Adequate (Basic |
| Example 2 | | blur) | and uneven | features often | detection only) |
| Absorber | | | regions | unreadable | |
| | | | remain) | | |

In summary, the present invention provides a dual-functional NIR-visible hybrid ink composition that incorporates both NIR-absorbing compounds and visible colorants. The ink composition is configured to absorb radiation in the NIR spectral region while simultaneously providing visible coloration for aesthetic enhancement and functional design requirements.

In addition, the present invention encompasses a particle size reduction process, such as milling, to improve the dispersion uniformity and printability of the NIR absorbers within the ink matrix. The formulation further includes strategies to enhance lightfastness, thereby ensuring long-term durability and resistance to degradation under environmental stressors such as light, heat, and humidity.

A distinctive feature of the present invention is its ability to integrate visible colorants with NIR-absorbing materials in a manner that achieves both high color purity and effective security functionality. This optimized balance makes the ink composition particularly suitable for applications requiring both visual appeal and robust anti-counterfeiting performance. The developed ink demonstrates superior stability and performance, meeting or exceeding the standards of existing commercial security ink products.

The functional units and modules of the anti-counterfeit systems and/or methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An anti-counterfeit system, comprising:
a dual-functional security ink composition exhibiting both near-infrared (NIR) absorption and visible coloration, having a viscosity of 10 to 1,250 cP and a pH between 6 and 8, comprising:
a NIR absorbing compound in an amount ranging from 0.5% to 10% by weight (w/w); and
one or more visible colorants in an amount ranging from 0.5% to 10% w/w;
a security feature printing module configured to print a security feature using the dual-functional security ink composition, wherein the security feature is machine-readable under illumination with NIR light in the wavelength range of 700-1,000 nm;
an image acquisition device comprising a portable NIR imaging camera or scanner configured to capture an NIR image of the security feature and an optical image camera configured to capture an optical image of the security feature; and
a computer system configured to process the NIR image of the security feature through:
applying a bilateral filtering to the NIR image to reduce noise while preserving edge features;
performing a contrast-limited adaptive histogram equalization (CLAHE) on the filtered NIR image to enhance local contrast between inked regions and a background substrate;
converting the contrast-enhanced image into a binary image using Otsu thresholding;
performing image upscaling to improve resolution of the binary image; and
generating an enhanced NIR image suitable.

2. The anti-counterfeit system of claim 1, wherein the NIR absorbing compound comprises one or more of:
a nickel dithiolene derivative, having the formula: 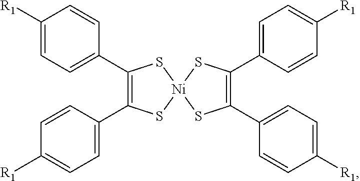
wherein R₁ is a hydrogen atom, aryl, arylalkyl, substituted aromatic cycles containing halogen, halo alkyl, ester, imide, diimide, nitro, cyano, carbonyl, or sulfonyl group;
a nickel phenylenediamine derivative, having the formula: 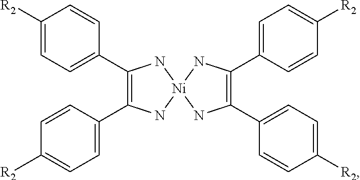
wherein R₂ is a hydrogen atom, aryl, arylalkyl, substituted aromatic cycles containing halogen, halo alkyl, ester, imide, diimide, nitro, cyano, carbonyl, or sulfonyl group;
copper phosphate ester having the formula of CuPO₃R₃, wherein R₃ is a hydrogen atom, alkyl or alkoxy group; and
cesium tungsten oxide having the formula of: CsₓWO₃, wherein 0<x<1.

3. The anti-counterfeit system of claim 1, wherein the ratio of visible colorant to NIR absorbing compound is selected to produce a visibly colored security feature detectable under visible light or a visibly colorless security feature detectable only under NIR light.

4. The anti-counterfeit system of claim 1, wherein the computer system further comprises a step of comparing the enhanced NIR image with a stored reference image of the security feature for evaluate the authentication of the security feature.

5. The anti-counterfeit system of claim 1, wherein the security feature comprises one or more of a barcode, microtext, a logo, a QR code, or a geometric pattern.

6. The anti-counterfeit system of claim 1, wherein the NIR image acquisition device is integrated into a mobile device, smartphone, or handheld scanner.

7. The anti-counterfeit system of claim 1, wherein the enhanced NIR image is used for real-time authentication of secure documents, currency, identification cards, or product packaging.

8. The anti-counterfeit system of claim 1, wherein the computer system is further configured to output an authentication signal to a user interface indicating whether the security feature is verified or counterfeit.

9. The anti-counterfeit system of claim 2, wherein the dual-functional security ink composition further comprises:
one or more additives in an amount ranging from 2% to 8% w/w, comprising at least one surfactant; and
a solvent in an amount ranging from 70% to 90% w/w;
wherein the at least one surfactant comprises ethylene glycol, polyethylene glycol, or a combination thereof; and
the solvent comprises one or more of water, alcohols, polyols, esters, ketones, and glycerol.

10. The anti-counterfeit system of claim 1, wherein the visible colorants provide visible coloration under daylight and comprise one or more of acid dyes, basic dyes, solvent dyes, direct dyes, disperse dyes, mordant dyes and reactive dyes.

11. The anti-counterfeit system of claim 1, wherein the NIR absorbing compound has an average particle size (d₅₀) not exceeding 50 nm and a lightfastness rating of at least 5 on the international blue wool scale, providing long-term durability and resistance to fading.

12. The anti-counterfeit system of claim 1, wherein the dual-functional security ink composition maintains at least 90% of its initial NIR reflectance properties after humidity aging at 85° C. and 85% relative humidity for 500 hours.

13. The anti-counterfeit system of claim 1, wherein the NIR absorbing compound exhibits high optical stability, minimizing the degradation under prolonged exposure to UV light, heat, or humidity.

14. A method of authenticating a security feature printed with a dual-functional ink composition, the method comprising:
capturing a NIR image of the security feature using an NIR imaging device, the ink composition exhibiting NIR absorption in the wavelength range of 700-1,000 nm, wherein the security feature is in a visibly colored or a visibly colorless form;
applying a bilateral filtering to the NIR image to reduce noise while preserving edge features;
performing a CLAHE on the filtered image to enhance local contrast between inked regions and a background substrate;
converting the contrast-enhanced image into a binary image using Otsu thresholding;
performing image upscaling to improve resolution of the binary image;
generating an enhanced NIR image; and
comparing the enhanced NIR image with a stored reference image of the security feature to generate an authentication result;
wherein the dual-functional ink composition exhibits both NIR absorption and visible coloration, having a viscosity of 10 to 1,250 cP and a pH between 6 and 8, comprising:
a NIR absorbing compound in an amount ranging from 0.5% to 10% by weight (w/w), comprising one or more of:
a nickel dithiolene derivative, having the formula: 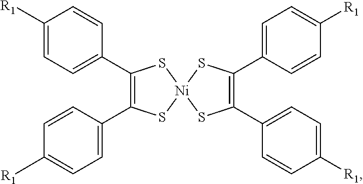
wherein R₁ is a hydrogen atom, aryl, arylalkyl, substituted aromatic cycles containing halogen, halo alkyl, ester, imide, diimide, nitro, cyano, carbonyl, or sulfonyl group;
a nickel phenylenediamine derivative, having the formula: 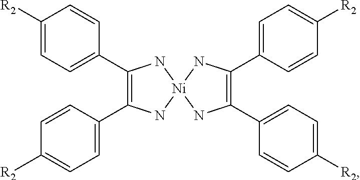
wherein R₂ is a hydrogen atom, aryl, arylalkyl, substituted aromatic cycles containing halogen, halo alkyl, ester, imide, diimide, nitro, cyano, carbonyl, or sulfonyl group;
copper phosphate ester having the formula of CuPO₃R₃, wherein R₃ is a hydrogen atom, alkyl or alkoxy group; and
cesium tungsten oxide having the formula of: CsₓWO₃, wherein 0<x<1; and
one or more visible colorants in an amount ranging from 0.5% to 10% w/w, comprising one or more of acid dyes, basic dyes, solvent dyes, direct dyes, disperse dyes, mordant dyes and reactive dyes.

15. The method of claim 14, further comprising performing spectral analysis of the enhanced NIR image to verify the presence of the dual-functional ink composition.

16. The method of claim 14, wherein the security feature comprises one or more of a barcode, QR code, logo, microtext, or geometric pattern.

17. The method of claim 14, wherein the authentication result is output through a user interface as a verification signal indicating whether the security feature is genuine or counterfeit.

18. The method of claim 14, wherein the security feature is printed on a substrate comprising a paper, a polymer film, a metal foil, and a product packaging.

19. The method of claim 14, wherein the comparison is performed in real-time using a mobile device, smartphone, or portable scanner.

20. The method of claim 14, wherein the dual-functional ink composition further comprising:
one or more additives in an amount ranging from 2% to 8% w/w, comprising at least one surfactant; and
a solvent in an amount ranging from 70% to 90% w/w;
wherein the at least one surfactant comprises ethylene glycol, polyethylene glycol, or a combination thereof; and
the solvent comprises one or more of water, alcohols, polyols, esters, ketones, and glycerol.
